(19) United States
(12) Patent Application Publication
(10) Pub. No.: US 2012/0111375 A1
(43) Pub. Date: May 10, 2012

(54) DEVICE AND METHOD FOR DISLODGING ACCRUED DEPOSITS

(76) Inventors: Yuri ASS, Beer Sheva (IL); Gennadi KABISHCHER, Beer-Sheva (IL); Oded ROSE, Herzlia (IL)

(21) Appl. No.: 12/943,176

(22) Filed: Nov. 10, 2010

(51) Int. Cl. B08B 5/02; A47L 5/00

(52) U.S. Cl. 134/37; 15/405; 15/319; 15/320

(57) ABSTRACT

A device for dislodging accrued deposits is disclosed. The device includes a gas impulse generating device for generating gas blasts directed in a predetermined direction; and an additive supply device for introducing an additive into the gas blasts.

A method and a computer program product for dislodging accrued deposits are also disclosed.

### FIELD OF THE INVENTION

The present invention relates to deposit removal. More specifically the present invention relates to device and method for dislodging accrued deposits.

### BACKGROUND

In many industrial installations handling processes involving various materials, in particular granular or particulate materials, or in high temperature processes, a buildup of deposits is evident on the walls of pipes, containers, ducts, boilers, heat-exchangers and other vessels of these installations.

Particulate matters accrete on walls of vessels, decreasing space for the processed materials within these vessels, narrowing passages and even causing complete blockage in extreme cases.

There are known solutions to this problem. The simplest solution involves using a hammer and a chisel to remove the accreted deposits. This takes up human work time, and is possible only when the deposits are easily accessible.

However, in many instances it may be impossible or dangerous to access or to manually remove the deposits.

There are several other cleaning methods available. One method utilizes a device commonly referred to in the art as a “whip.” This device is pneumatically or hydraulically driven, and consists of a cutting head supported from a roof opening of the vessel to be cleaned, e.g. a silo. The cutting head rotates rapidly so that flail chains attached to the head repeatedly strike the layer of accumulated material while the head is progressively translated upward or downward within the silo. This process is generally slow and rather cumbersome, and often poses a risk of damage to the silo being treated.

Moreover in hot environments it may be impossible to apply these means.

In industrial processes handling particulate solids and liquids, preheating or heating them, as well as dealing with high temperature gas flow, heavy build-up of deposits occurs in various vessels. Such vessels may include cement plant preheaters, rising ducts, cyclones and steam boilers (e.g. boilers at power stations).

Typically, the initial deposit build-up begins as a result of condensation of low and medium melting temperature compounds on the walls. This causes a sticky layer to form over the wall, and it serves as a basis for the following build up formation.

Once the initial sticky (melted) layer has been created, hard particles (e.g. raw material particles and high-temperature melting compound particles) accumulate over it preventing the initial layer from contact with high-temperature gases within the vessel. As a result, the initial sticky layer cools down and hardens.

The common way to deal with deposit build-up in preheaters and similar vessels is to employ water jets under high (300-700 bar) pressure for periodical cleaning the build-up through a plurality of small openings in the walls. This cleaning process is carried out when heavy build-up is created, and is a manual and dangerous operation, both manpower and time consuming.

Another way of build-up cleaning and prevention is using air cannons, which are installed around the vessel and directed into it and which cause sudden release of compressed air with typical working pressures of up to 7 bars directed to the accrued build-up.

Gas impulse devices which prevent or remove aggregated particles by disaggregating them are also known. U.S. Pat. No. 6,630,032 (Carmi et al.), incorporated herein by reference in its entirety, disclosed an apparatus for dislodging an accretion of a substance from the vicinity of a vessel. It includes apparatus for generating gas-borne shock waves in the vicinity of a vessel, thereby to expose a substance accrued on a surface of the vessel to separation forces causing at least partial separation of the substance from the surface, so as to facilitate removal of the at least partially separated substance therefrom; and support apparatus for supporting the apparatus for generating shock waves in a selected association relative to the vessel (and see also U.S. Pat. No. 6,250,388, incorporated herein by reference in its entirety). This apparatus operates at high pressures (up to 250 bars). Generally, the apparatus is directed into a vessel in the vicinity of agglomerated material. Often the particulates, aggregated or separated, block at least partially, near the gas discharge ports of these devices. These ports serve as the point of exit of the impulse producing gas from the device into the vessel.

### SUMMARY

According to embodiments of the present invention there is provided a device for dislodging accrued deposits. The device may include a device for generating gas blasts directed at a predetermined direction, and an additive supply device for introducing an additive into the gas blasts.

Furthermore, according to embodiments of the present invention, the additive may be selected from the group of additives consisting of liquid additives, water, foam, jell, liquid carbon dioxide, hydrocarbons, particulate solid additives, sand, gravel, solid carbon dioxide and clinker.

Furthermore, according to embodiments of the present invention, the additive supply device may include a controllable valve.

Furthermore, according to embodiments of the present invention, the device may include a controllable high-pressure gas supply valve.

Furthermore, according to embodiments of the present invention, the device may include one or more sensors.

Furthermore, according to embodiments of the present invention, the device may include a controller for controlling operation of the additive supply device

Furthermore, according to embodiments of the present invention, the controller may be configured to synchronize the gas blasts with the introduction of the additive into the blasts.

Furthermore, according to embodiments of the present invention, the device may include storage medium for storing computer executable program including code for operating the device for generating gas blasts and the operation of the additive supply device. The device may also include a processor for executing the computer executable program.

Furthermore, according to embodiments of the present invention, the device may include an I/O device.

Furthermore, according to embodiments of the present invention, there is provided a method for dislodging accrued deposits. The method may include providing a device for dislodging accrued deposits, that includes a device for generating gas blasts directed at a predetermined direction, and an additive supply device for introducing an additive into the gas blasts. The method may further include directing a gas blast discharge outlet of the device for generating gas blasts to the accrued deposits. The method may also include generating gas blasts by the device for generating gas blasts while introducing an additive into the blasts.

Furthermore, according to embodiments of the present invention, the method may include operating the device for dislogding accrued deposits at one or more predetermined operation parameters, monitoring effects of the operation and adjusting the operation parameters according based on the monitored effects.

Furthermore, according to embodiments of the present invention, said one or more predetermined operation parameters are selected from the group of parameters consisting of pressure supplied into the gas impulse device, frequency of firing, and amount of additives.

Furthermore, according to embodiments of the present invention, the step of introducing an additive includes introducing an additive is selected from the group of additives consisting of a liquid additives, water, foam, jell, liquid carbon dioxide, hydrocarbons, particulate solid additives, sand, gravel, solid carbon dioxide and klinker.

Furthermore, according to embodiments of the present invention, the method may include synchronizing the generation of gas blasts with the introduction of the additive into the gas blasts.

Furthermore, according to embodiments of the present invention, the synchronizing of the generation of gas blasts with the introduction of the additive into the gas blasts may include using a sensor to sense at least one physical parameter.

Furthermore, according to embodiments of the present invention, the method may include providing a storage medium for storing computer executable program including code for operating the device for generating gas blasts and the operation of the additive supply device, and a processor for executing the computer executable program. The method may also include executing the computer executable program.

Furthermore, according to embodiments of the present invention, the method may include providing a user input device and inputting user commands

Furthermore, according to embodiments of the present invention, the method may include providing an output using an output device.

Furthermore, according to embodiments of the present invention, the method may be performed on accrued deposits found in one or more vessels selected form the group of vessels consisting of pipes, containers, preheaters, coolers, ducts, boilers and heat-exchangers.

Furthermore, according to embodiments of the present invention, there is provided a computer program product stored on a non-transitory tangible computer readable storage medium. The computer program may include code for operating a device for dislodging accrued deposits that includes a device for generating gas blasts directed in a predetermined direction, and an additive supply device for introducing an additive into the gas blasts. The code may include instructions for generating gas blasts by the device for generating gas blasts and introducing an additive into the gas blasts.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings. It should be noted that the figures are given as examples only and in no way limit the scope of the invention. Like components are denoted by like reference numerals.

FIG. 1 illustrates a cross sectional view of a device for dislodging an accretion of deposits, according to embodiments of the present invention, in an initial state prior to generating a gas blast.

FIG. 2 illustrates a cross sectional view of a device for dislodging an accretion of deposits, according to embodiments of the present invention, in a gas blasting state.

FIG. 3 is a block diagram of a system for dislodging accrued deposits according to embodiments of the present invention.

FIG. 4 is a flow chart of an algorithm for operating a device for dislodging accrued deposits, according to embodiments of the present invention.

### DETAILED DESCRIPTION

The present invention seeks to provide a system and method for effective removal of accreted deposits and maintenance of vessels. More specifically, the present invention is aimed at providing a system and method for loosening and removing accretions of accumulated sticky or hard material, and particulate solids from within a vessel, particularly in, but not limited to, a dry (non-liquid) environment. More specifically, the present invention is aimed at providing a system and method for loosening and removing accretions of accumulated sticky or hard material, and particulate solids from within a vessel, particularly in, but not limited to, extremely hot industrial environments such as in preheaters, cyclones, and boilers. Additionally, the present invention provides a system and method for automatically and/or manually controlling the extent of the vessel wall cleaning.

In seeking to achieve the above objectives, and in accordance with some embodiments of the present invention, a gas blast generating device is provided and positioned in an enclosure member fastened to a vessel wall adjacent to and abutting an opening in the wall. The vessel may contain an accretion of build-up which needs removing.

According to embodiments of the present invention, the device is operated so as to produce a series of gas blasts, each of them generating shock waves which are propagated through the vessel, to loosen and progressively separate the deposit build-up from surface or surfaces of the vessel to which they are attached, or from a region or regions of the vessel where they have accumulated. According to embodiments of the present invention one or more liquid additives (with or without inhibitors), e.g. water, foam, jell, liquid carbon dioxide, hydrocarbons, or particulate solid additive e.g., sand, gravel, solid carbon dioxide, in the form of, for example, pellets or clinker, or mixture thereof, is injected into a gas blast released into the vessel from the gas blast generating device.

The device includes an additive introducer which introduces liquid or particulate (or a mixture of) additives into the gas blast exiting the outlet of the device.

Liquid additive, such as, for example, water, may be injected at high speed into the vessel. In typical preheater facilities the temperature ranges from 300 C degrees to over 1000 C degrees. Thus when liquid whose boiling temperature is substantially lower than the temperature within the preheater, it is subjected to a steep temperature gradient and is instantly superheated causing a steam explosion, i.e. a violent boiling or flashing of water into steam. Water-steam expansion ratio is typically about 1700, e.g., 1 liter of water expands to 1700 liters when turning into steam. So when water is injected into a hot vessel, it undergoes steam explosion in the vicinity of the vessel walls to be cleaned.

The device for generating sudden gas blasts, according to embodiments of the present invention is made to release gas blasts concurrently with the injection of the additive thus the overall density of the mixture is higher than the mere gas released by the device without additives. Hence, a more powerful action may be achieved which combines a gas blast which is immediately followed by high velocity a gas-liquid jet. The shock wave acts on the deposit build-up to crack it and eventually remove it, and the high velocity gas-liquid jet following the shock wave exerts a shear effect on the deposit build-up.

According to embodiments of the present invention the injected jet may be acquired with proper initial velocity when injected into the vessel so that it reaches the deposit build-up before steam explosion occurs. It is asserted that this jet could partly penetrate into the deposit build-up which is not immediately removed by the initial shock wave. A steam explosion would occur, concurrently or in series with the gas blast hitting the deposit build-up within the space of the vessel.

According to embodiments of the present invention, a gas blast with additive liquid may be introduced into the vessel with the liquid in the form of mist. Depending on the gas pressure and amount of liquid the mist drops may be larger or smaller so that a various power of the steam explosion may be achieved.

Additives in the form of particulate solids may enhance the shear effect of the device when operative.

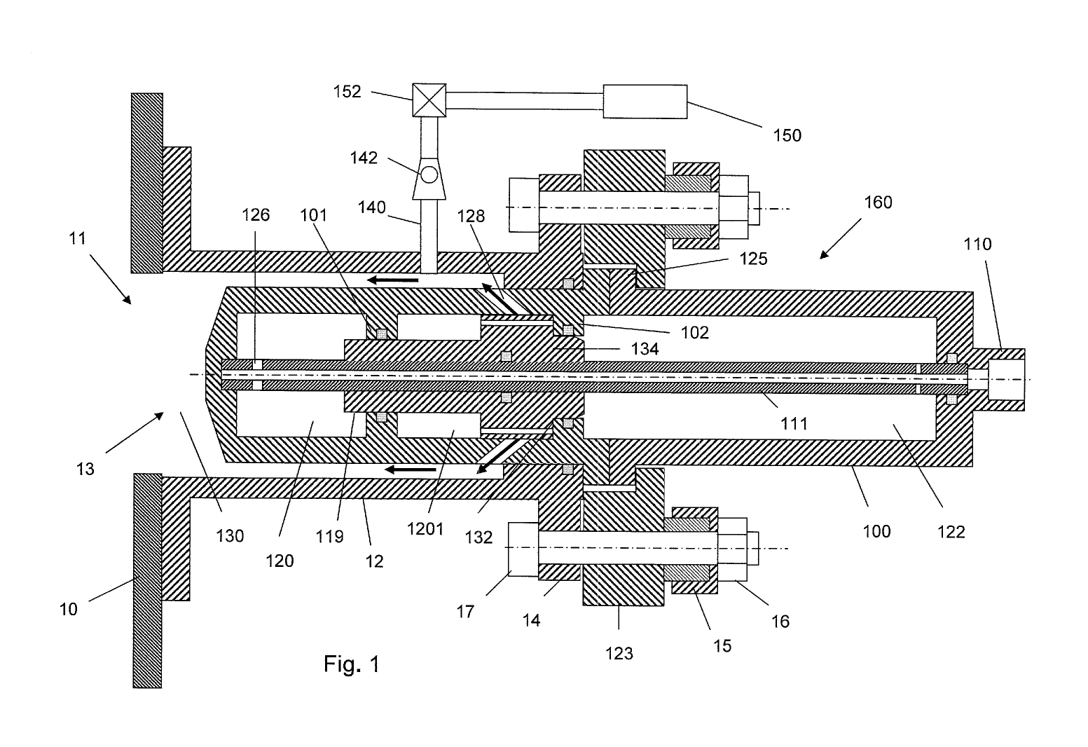

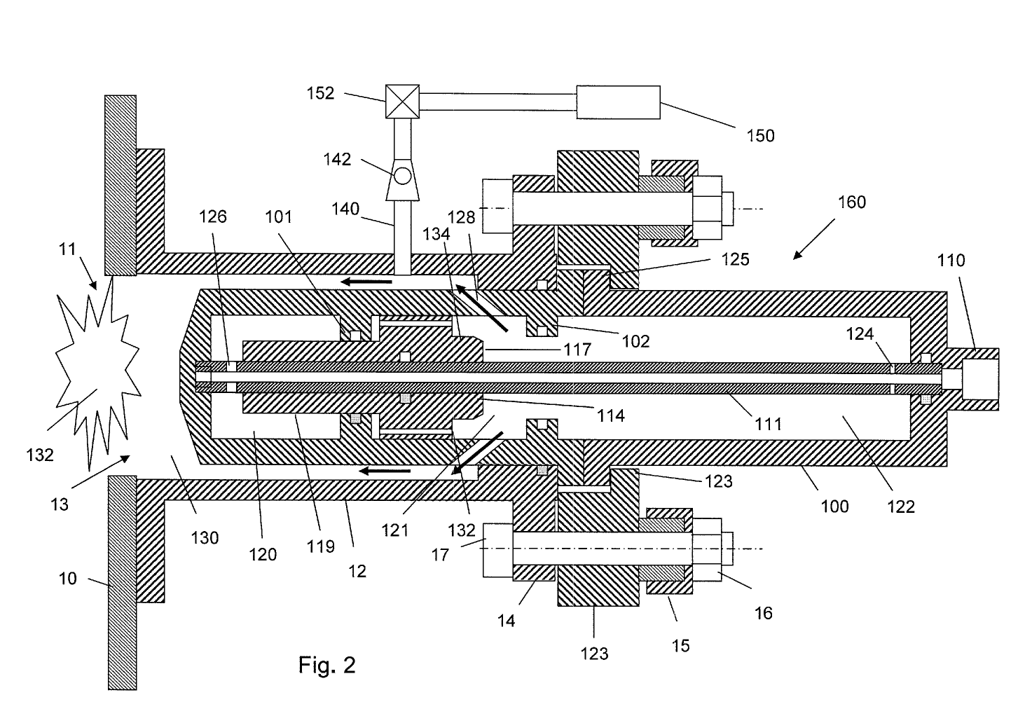

Reference is made to FIG. 1 illustrating a cross sectional view of a device 160 for dislodging an accretion of deposits, according to embodiments of the present invention, in an initial state prior to generating a gas blast and FIG. 2 illustrating a cross sectional view of a device for dislodging an accretion of deposits, according to embodiments of the present invention, in a gas blast state.

A rapid self-firing, gas impulse generating device, generally referenced 160, is presented. The device is attached to the wall of vessel 10 (e.g. a preheater facility leading into materials to be processed into a furnace) a over opening 11 in the wall. Support structure, here in the form of pipe 12 is provided over opening 11, for supporting Main body 100 over opening 11 of wall 10, pipe 12 including rim 14. Main body 100 of the device is mounted on pipe 12, so that a front portion from which gas blasts are emitted from, is accommodated within pipe 12, with space left between main body 100 and the wall of pipe 12, so as to allow gas to escape from within internal chamber 121, through vents 128, when piston 114 does not block sealing arrangement 102 (as will be explained hereinafter), directing the gas blasts towards a facing wall on which accrued deposits are found. Main body 100 is fixed over pipe 12 by holding plate 123, which is secured over rim 14 of pipe 12 by bolts 16, washers 15 and corresponding nuts 17. Holding plate 123 includes a protrusion 123 which rests over corresponding shoulder 125 of main body 100, holding it in place over pipe 12.

Main body 100, typically in the form of a cylinder, may be made of rigid material which may be designed to withstand high pressures and shocks (e.g. steel) and includes four chambers, 120, 121, 1201 (see FIG. 2) and 122. Piston 114, includes a bulbous head 117 and a narrower extension 119, and may be designed to move along an elongated tube 111, which may be fixed inside main body 100, running across the four chambers.

Piston 114 is typically formed of toughened stainless steel and has three integrally formed sub-units-namely: a longitudinally arranged piston body 119, a piston head 117, and a piston nose 134, protruding over shoulders 132.

Piston 114 may ride over tube 111, which passes through a longitudinal bore traversing piston 114. Tube 111 is hollow and is provided with inlet 110 which is connectable to a high-pressure gas reservoir, such as a high-pressure gas bank or compressor (not shown in the figure). Tube 111 has two outlet region—a first outlet region is located within chamber 120, and includes one or more orifices of predetermined diameter, and a second outlet region is located within chamber 122, and includes one or more orifices of predetermined diameter which is smaller than the diameter of the orifices at the first outlet region. When compressed gas flows from the high-pressure gas reservoir through inlet 110 into the tube 111, it enters into chamber 120 through orifices 126 and into chamber 122 through orifices 124. Orifices 120 may be made larger than orifices 124 and/or chamber 120 may be made smaller than chamber 122, so that the pressure within chamber 120 builds up faster than the pressure within chamber 122 and forces piston 114, whose head 117 is limited to move between sealing arrangement 101 and sealing arrangement 102 to move towards sealing arrangement 102. As a result of this movement piston nose 134 is pressed against sealing arrangement 102, sealing the passage between chambers 122 and 121, and blocking vents 128. from the chamber 122.

Following the full insertion of piston nose 134 into sealing arrangement 102 as described, the additional feeding of compressed gas into the device creates an increase in pressure within chamber 122. This increase in pressure exerts an increasing force on an end surface of piston nose 134 facing chamber 122. Once the force applied to this end surface exceeds the force applied on the opposite surface of the piston body facing chamber 120, and the friction forces between the piston, the sealing arrangements and adjacent surfaces of piston, tube and the main body, the piston unit starts moving towards chamber 120. It is noted that the pressure in chamber 122 required to initiate a traversal of the piston towards chamber 120, may be less than the magnitude of pressure within chamber 120.

As piston unit commences its traversal towards chamber 120, the resulting withdrawal of piston nose 134 from sealing arrangement 102 exposes shoulder 132 of piston to the gas pressure within chamber 122, such that an additional force is suddenly applied to shoulder 132. Thus, the initial upstream movement of piston unit, leads to a sudden increase in the force applied to surfaces of the piston unit facing the chamber 122, thereby causing a sudden, rapid movement of the piston unit towards chamber 120.

The rapid traversal of piston unit as described, causes an instantaneous opening of vents 128, which in turn provides for a rapid discharge of pressurized gas from chamber 122 into pipe 12 through which gas is suddenly blasted to generate a shock wave 132 exiting through outlet 13 of the device into vessel 10.

When piston 114 continues its movement towards chamber 120, the inner dimensions of chamber 121 increase in size thereby providing an enlarged passage for pressurized gas to flow from chamber 122 to ports 128. At the same time, chamber 1201 decreases in size until it becomes a small annular volume, formed between piston unit and sealing arrangement 101.

Furthermore, owing to the decrease in pressure within this chamber 122 upon the release of pressurized gas via vents 128 and pipe 12, and the increased pressure in both chamber 120 and chamber 1201, the respective forces applied to shoulder 132 of piston and the end surface of piston body 119 facing the chamber 120, cause piston unit 114 to move rapidly back to its initial “pre-firing” position.

It will be appreciated that in practice, the entire gas blast cycle described above is rapidly repeated by continuing the supply of compressed gas to the device.

A device for generating sudden gas blasts typically operates at high input supply pressures (e.g. between 50 to 250 bars, and in particular between 75-150 bars).

Additive introducer 150 injects, through pipe 140, one or more additives into space 130 of the device, which is the space the gas flows though prior to leaving pipe 12 through outlet 13. Supply valve 152 may be operated manually or controlled automatically to introduce the additive into the gas blast.

Inverse valve 142 may be provided, to prevent counter flow within pipe 140 as a result of the enormous pressure gradient caused by the blast.

Additives may include various liquids or particulate solids. For example, liquid additives may include example, water, foam, jell, liquid carbon dioxide, hydrocarbons. The liquid additives may be with or without inhibitors. Additives in the form of particulate solids may include, for example, sand, gravel, solid carbon dioxide, e.g. in the form of pellets, clinker. The additive used may also be in the form of a mixture of liquids, mixture of particulate solids or a mixture of liquid and particulate solids.

Liquid additives, for example, water, may be enhance the operation of dislodging accretion of deposits off the walls of a vessel within which extremely high temperatures prevail, e.g. a preheater. Typical temperatures prevailing within a preheater, through which materials to be processed in an industrial furnace are passed, are in the order of a few hundreds of degrees Centigrade (e.g. 300-1000 C degrees). As water droplets are abruptly sprayed out of outlet 13 of device 160 into the inside of a preheater they are subjected to a steep temperature gradient which leads to a steam explosion. This explosion further increases the force exerted on the accrued deposit on the wall causing it to disintegrate and consequently disengage from the wall.

Device 160 may operate effectively in any desired orientation (e.g. it may be used for cleaning vertical, horizontal and inclined walls and facilities).

It will be appreciated that in practice, the entire gas blast cycle described above is rapidly repeated by continuing the supply of compressed gas through inlet 110. Typically, gas impulse device 160 is capable of firing at an approximate rate of between 3 gas blasts per second to 1 gas blast per 20 seconds, but for many purposes a firing rate of 1 blast per 3-4 seconds would suffice. Once a desired number of gas blast cycles has been achieved, operation of the apparatus may be terminated by ceasing the supply of compressed gas to inlet 110.

The operation of device 160 may be controlled manually by an operator or suitable computerized controlling program. For example, the supply of gas through inlet 110 may be controlled by a flow restrictor controlled by an operator or a controller.

Generally speaking, the device for dislodging an accretion of deposits, according to embodiments of the present invention, may be employed in various tasks where sudden gas blast or shock wave are desired. For example, in cleaning and maintenance of facilities of any type. Similarly, the apparatus of the invention may be used for the cleaning and maintenance of tanks, bunkers, bins, crucibles, channels, reservoirs, and other similar liquid or dry storage and transport facilities where accrued deposits are found.

According to some embodiments of the present invention, the devices 160 for dislodging accrued deposits are positioned near or at corners of the vessel and are directed to fire the gas blast into the vessel, substantially parallel to the wall, thus exerting shear forces on the accrued deposits.

According to embodiments of the present invention, one or more of device 160 for dislodging accrued deposits may be positioned facing heat exchanger (or heat-exchangers) of boilers to remove deposit build-up from the heat exchangers surfaces.

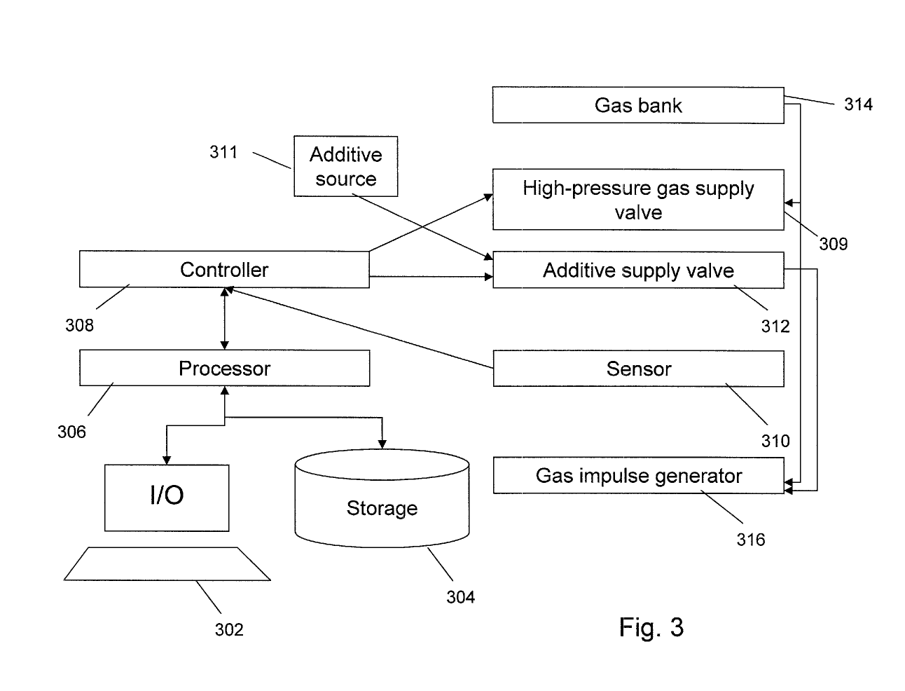

FIG. 3 is a block diagram of a system for dislodging accrued deposits according to embodiments of the present invention.

A system for dislodging accrued deposits, in accordance with embodiments of the present invention, may include a gas impulse generating device 316, such as, for example, device 160 generating gas blasts, which is described hereinabove and in FIGS. 1 and 2, or a gas impulse generating device as described in U.S. Pat. No. 6,630,032, U.S. Pat. No. 6,250,388 (Carmi et al.), or air guns manufactured, for example, by Bolt Corp., or air cannons manufactured, for example, by Martin Engineering, or any other devices for generating gas blasts, all incorporated herein by reference in their entirety, which is controlled by a controller 308, which controls the operation of pressurized gas supply valve 309, and additive supply valve 312. Gas bank 314 supplies pressurized gas to device for generating gas blasts 316 via gas supply valve 309. Additives are introduced from additive source 311 into the gas blast generated by device for generating gas blasts 316, through additive supply valve 312. According to some embodiments of the present invention the controller is configured to synchronize the blasts with the introduction of the additive.

In some embodiments of the present invention, both the high pressure gas supply valve 309 and additive supply valve 312 may be activated and set manually instead of using the controller 308.

The system and its operation may be monitored by an operator or by means of sensors. In some embodiments of the present invention the operator may adjust operation parameters (such as, for example, pressure, frequency of gas releasing, amount of additives), based on the monitored results.

One or more sensors 310 may be provided to sense one or more physical parameters associated with the operation of device for generating gas blasts 316. For example, said one or more sensor may include a pressure sensor for sensing the gas jet or pressure changes inside the vessel, a sensor for sensing movement of the piston within the device for generating gas blasts 316, a pressure sensor for sensing pressure within one or more of the chambers within the device for generating gas blasts 316. Said one or more sensors 310 may be provided to sense one or more ambient parameters, such as, for example, a temperature sensor for sensing the ambient temperature, a proximity sensor for sensing the thickness of accrued deposits facing the device for generating gas blasts 316, a sensor for sensing changes within the vessel. Other types of sensors for sensing the above mentioned parameters or other parameters, may also be used. Sensor 310 sends signals to controller 308. Sensor 310 may be used so as to enable synchronizing the operation of additive supply valve 312 with the operation of gas impulse generating device 316.

A device for dislodging accrued deposits, according to embodiments of the present invention, may be operated by a computing device running an algorithm. The algorithm may be stored on a storage medium 304, and run on processor 306, which operates controller 308. Optional input/output (I/O) capabilities may be obtained by providing I/O device 302, to allow a user to input data or instructions and to obtain information on the operation of the device for dislodging accrued deposits (e.g. display information on a monitor, obtain a printout from a printer, sound an audio signal from an audio generator).

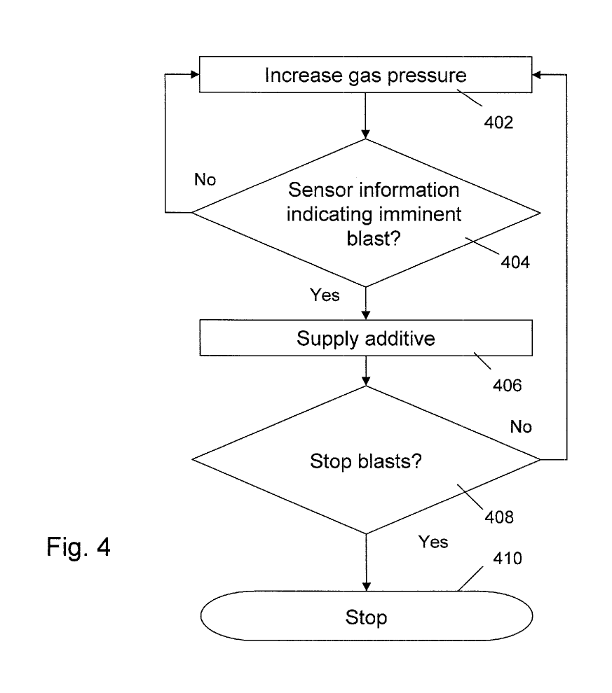

FIG. 4 illustrates an algorithm for operating a device for dislodging accrued deposits, according to embodiments of the present invention, which may be used, for example, in conjunction with the system depicted in FIG. 3.

The algorithm may be a computer program product stored on a non-transitory tangible computer readable storage medium. The computer program may include code for operating a device for dislodging accrued deposits, that includes a device for generating gas blasts, directed in a predetermined direction, and an additive supply device for introducing an additive into the gas jets. The code may include instructions for generating gas jets by the device for generating gas blasts; and introducing an additive into the gas jet.

For example, in order to synchronize the gas jets with the supply of the additive, the code may include an instruction to increase the gas pressure 402 supplied into the device for generating gas blasts. It is then determined whether sensor information was received, indicative of imminent blast 404. This can be obtained, for example, by monitoring the pressure within one or more of the chambers within the device for generating gas blasts, and determining whether a pressure threshold was reached which is known to be indicative of imminent blast. Alternatively, other parameters may be sensed to facilitate arriving at a conclusion that a blast is imminent.

If blast is not imminent then the gas pressure is further increased. If blast is imminent then additive is supplied 406.

This may be repeated until a stop command is issued 408, wherein the algorithm is terminated 410.

The device and method according to embodiments of the invention, provide an effective means for dislodging of deposits and encrustations on a vessel wall, or on heat exchangers surfaces due to the repeated powerful shock waves generated by gas blasts; the resulting vibrations of surfaces upon which the deposits or encrustations are lodged; the mixture of gas and additives and the sudden increase in pressure within the pores of deposits or encrustations, thereby resulting in the fracture of those deposits or encrustations.

In the case of very hot environments, the introduction of liquid additives, whose boiling temperature is substantially lower than the ambient temperature within the vessel, the effects of steam explosion enhance the effectiveness of dislodging of deposits and encrustations on a vessel wall.

Aspects of the present invention, as may be appreciated by a person skilled in the art, may be embodied in the form of a system, a method or a computer program product. Similarly, aspects of the present invention may be embodied as hardware, software or a combination of both. Aspects of the present invention may be embodied as a computer program product saved on one or more computer readable medium (or mediums) in the form of computer readable program code embodied thereon.

For example, the computer readable medium may be a computer readable signal medium or a computer readable non-transitory storage medium. A computer readable storage medium may be, for example, an electronic, optical, magnetic, electromagnetic, infrared, or semiconductor system, apparatus, or device, or any combination thereof.

A computer readable signal medium may include a propagated data signal with computer readable program code embodied therein, for example, in baseband or as part of a carrier wave. Such a propagated signal may take any of a variety of forms, including, but not limited, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code in embodiments of the present invention may be written in any suitable programming language. The program code may execute on a single computer, or one a plurality of computers.

Aspects of the present invention are described hereinabove with reference to flowcharts and/or block diagrams depicting methods, systems and computer program products according to embodiments of the invention.

It will be appreciated by persons skilled in the art, that the full scope of the invention and its applications, extends well beyond the various embodiments of the invention described hereinabove.

It will thus be appreciated by persons skilled in the art, that the present invention is not limited by what has been shown and described hereinabove merely by way of illustrative example. Rather, the scope of the present invention is limited solely by the claims which follow.

What is claimed is:

1. A device for dislodging accrued deposits, the device comprising:
a device for generating gas blasts directed at a predetermined direction; and
an additive supply device for introducing an additive into the gas blasts.

2. A device as claimed in claim 1, wherein the additive is selected from the group of additives consisting of liquid additives, water, foam, jell, liquid carbon dioxide, hydrocarbons, particulate solid additives, sand, gravel, solid carbon dioxide and clinker.

3. A device as claimed in claim 1, wherein the additive supply device includes a controllable valve.

4. A device as claimed in claim 1, which includes a controllable high-pressure gas supply valve.

5. A device as claimed in claim 1, comprising at least one sensor.

6. A device as claimed in claim 1, comprising a controller for controlling operation of the additive supply device

7. A device as claimed in claim 6, wherein the controller is configured to synchronize the gas blasts with the introduction of the additive into the blasts.

8. A device as claimed in claim 1, comprising:
storage medium for storing computer executable program including code for operating the device for generating gas blasts and the operation of the additive supply device; and
a processor for executing the computer executable program.

9. A device as claimed in claim 8, comprising an I/O device.

10. A method for dislodging accrued deposits comprising:
providing a device for dislodging accrued deposits, that includes a device for generating gas blasts directed at a predetermined direction, and an additive supply device for introducing an additive into the gas blasts;
directing a gas blast discharge outlet of the device for generating gas blasts to the accrued deposits; and
generating gas blasts by the device for generating gas blasts while introducing an additive into the blasts.

11. A method as claimed in claim 10, comprising:
operating the device for dislogding accrued deposits at one or more predetermined operation parameters;
monitoring effects of the operation; and
adjusting the operation parameters according based on the monitored effects.

12. A method as claimed in claim 11, wherein said one or more predetermined operation parameters are selected from the group of parameters consisting of pressure supplied into the gas impulse device, frequency of firing, and amount of additives.

13. A method as claimed in claim 10, wherein the step of introducing an additive includes introducing an additive is selected from the group of additives consisting of a liquid additives, water, foam, jell, liquid carbon dioxide, hydrocarbons, particulate solid additives, sand, gravel, solid carbon dioxide and klinker.

14. A method as claimed in claim 10, comprising synchronizing the generation of gas blasts with the introduction of the additive into the gas blasts.

15. A method as claimed in claim 14, wherein the synchronizing of the generation of gas blasts with the introduction of the additive into the gas blasts includes using a sensor to sense at least one physical parameter.

16. A method as claimed in claim 10, comprising:
providing a storage medium for storing computer executable program including code for operating the device for generating gas blasts and the operation of the additive supply device, and a processor for executing the computer executable program; and
executing the computer executable program.

17. A method as claimed in claim 16, comprising providing a user input device and inputting user commands.

18. A method as claimed in claim 16, comprising providing an output using an output device.

19. A method as claimed in claim 10, performed on accrued deposits found in one or more vessels selected form the group of vessels consisting of pipes, containers, ducts, preheaters, coolers, boilers and heat-exchangers.

20. A computer program product stored on a non-transitory tangible computer readable storage medium, the computer program including code for operating a device for dislodging accrued deposits, that includes a device for generating gas blasts directed in a predetermined direction, and an additive supply device for introducing an additive into the gas blasts; the code including instructions for
generating gas blasts by the device for generating gas blasts; and
introducing an additive into the gas blasts.
